(19) United States
(12) Patent Application Publication
(10) Pub. No.: US 2017/0178089 A1
(43) Pub. Date: Jun. 22, 2017

(54) BARCODE READER CONNECTED TO THE BANK ACCOUNT OF THE VENDOR

(71) Applicant: Lorita Bolts, Hawthorne, CA (US)

(72) Inventor: Lorita Bolts, Hawthorne, CA (US)

(21) Appl. No.: 14/970,556

(22) Filed: Dec. 16, 2015

(51) Int. Cl. G06Q 20/08; G06K 7/06; G06K 7/14

(52) U.S. Cl. CPC G06Q 20/085; G06K 7/1413; G06K 7/065

(57) ABSTRACT

Disclosed is barcode reader apparatus placed at a store for communicating the store bank with the vendor's bank over a communication network. The barcode reader apparatus scans a barcode chip attached to a product. The barcode reader apparatus includes a housing handheld by the store manager or a clerk, in-counter barcode scanner for decoding the barcode chip, a memory unit for storing information related to vendor, vendor's bank, products at the store etc, and a processor coupled to memory unit for processing the decoded information and thereafter communicating with store's bank/customer's bank account for transferring the vendor price associated with the product to the vendor's bank account.

### BACKGROUND OF THE INVENTION

1. Field of the Invention

The present invention generally pertains to the field of digital scanning, computing, data collection and data processing devices and electronic use, and more particularly relates to a barcode reader apparatus connected to the bank account of the vendor.

2. Description of Related Art

A barcode is an optical machine-readable representation of data. Originally, barcodes represented data, by varying the programmed barcode chip. These types of barcodes may be referred to as programmed barcode chips or one-dimensional (1D) barcodes. Later, barcodes evolved into rectangles, dots, hexagons and other geometric patterns in two dimensions (2D).

Although 2D systems use a variety of symbols, they are generally referred to as barcodes as well. Devices for identifying or extracting information from barcodes are generally referred to as barcode readers. Barcodes and barcode readers have a wide variety of uses. For example, almost every item from a grocery store, department store, or a mass product has a barcode on it.

Currently, most of the stores sell products created by different vendors e.g. clothes, food items, medicines, furniture, luggage bags etc. Stores keep and sell these products and pay the vendor only after a predetermined period such as 30 days, 60 days, 90 days or 120 days.

Therefore, there is a need of a barcode reader apparatus placed in a store for communicating the store bank with the vendor's bank. Further, the barcode reader apparatus scans information related to each product from the barcode chip.

### SUMMARY OF THE INVENTION

In accordance with the teachings of the present invention, a barcode reader apparatus for communicating the store bank with the vendor's bank over a communication network is provided.

An object of the present invention is to provide a barcode reader apparatus including a housing handheld by the store manager and or clerk, an in-counter barcode scanner capable of scanning and decoding barcodes information from the barcode chip. Further, the barcode reader apparatus include a memory unit and a processor.

The memory unit is for storing vendor's bank name, vendor's bank account number, routing number of the vendor's bank account, vendor's name, a special code and price of each product and the processor is coupled to the memory unit and the in-counter barcode scanner.

The processor is programmed to receive decoded alphanumeric characters from the in-counter barcode scanner; store the decoded alphanumeric characters in the memory unit; analyze the vendor price and selling price, routing number, and account number and a special code, and vendor's name, and financial institute programmed from the barcode chip; and communicating with the store's bank and or customer's bank account for transferring the vendor price associated with the product to the vendor's bank account.

In another object of the present invention, the processor is further programmed to send a transaction slip of the purchases to the vendor over the communication network.

These and other objects, features and advantages of the invention will become more fully apparent in the following detailed description, taken in conjunction with the accompanying drawings.

### BRIEF DESCRIPTION OF DRAWINGS

FIG. 1 illustrates a schematic diagram to show relationship in between the barcode scanner, the vendor's bank and the store's bank in a preferred embodiment of the present invention; and

FIG. 2 illustrates a block diagram for of a barcode reader apparatus for communicating the store and or the customer's bank with the vendor's bank in a preferred embodiment of the present invention.

### DETAILED DESCRIPTION OF DRAWINGS

While this technology is illustrated and described in a preferred embodiment, a barcode reader apparatus for communicating the store bank and or the customer's bank account with the vendor's bank may be produced in many different configurations, forms, computer languages and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

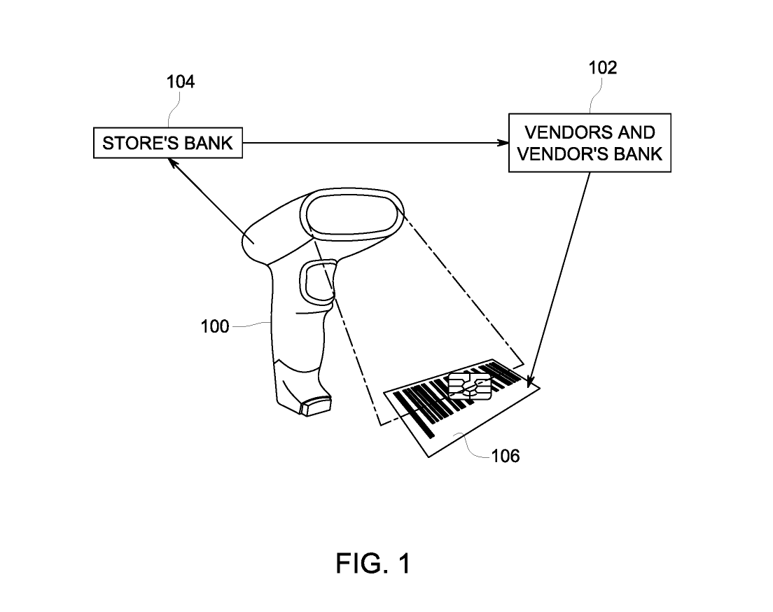

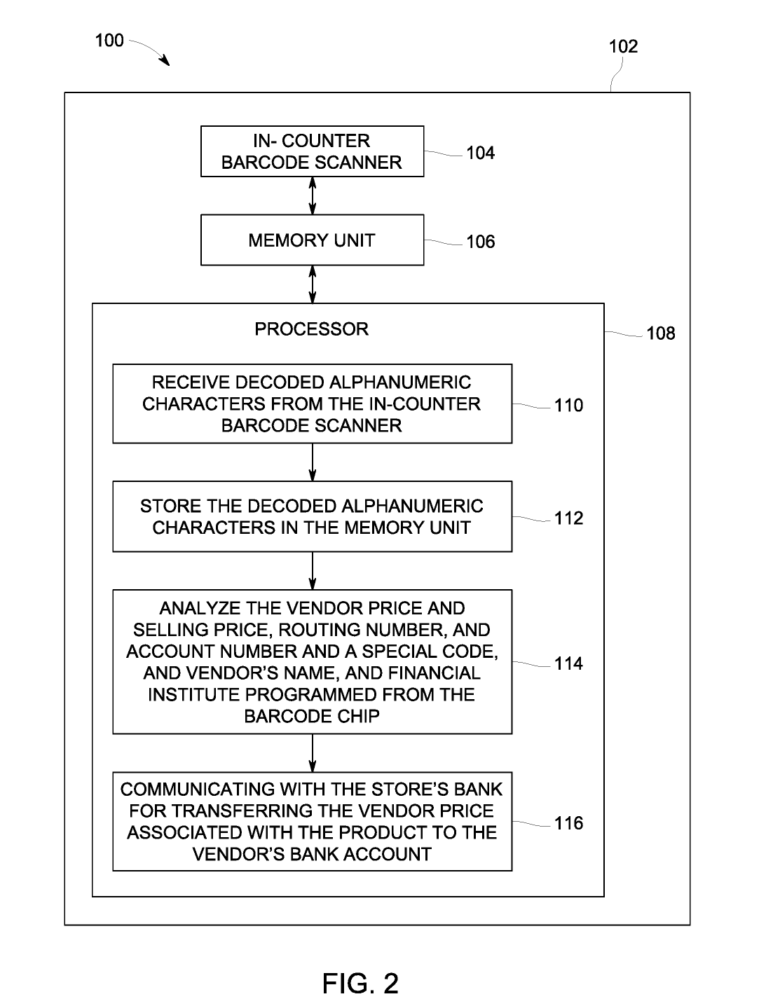

FIG. 1 illustrates a schematic diagram to show relationship in between the barcode reader apparatus 100, the vendor's and vendor's bank 102 and the store's bank 104 in a preferred embodiment of the present invention. The barcode reader apparatus 100 reads the information related to the vendor's and vendor's bank 102 from the barcode chip 106. The barcode reader apparatus 100 is explained in detail in conjunction with FIG. 2 of the present invention.

The barcode reader apparatus 100 directs the store's bank and or the customers account to transfer funds associated with the product to the vendor's bank over a communication network. The barcode chip 106 contains a product code associated with the product. The product code reflects multiple price of the product such as vendor price, selling price and store's commission price on the product. In a preferred embodiment of the present invention, the vendor's price is transferred by the store's bank and or the customer's bank account to the vendor's bank.

FIG. 2 illustrates a block diagram for of a barcode reader apparatus 100 for communicating the store bank and or customer's bank account with the vendor's bank in a preferred embodiment of the present invention. The barcode reader apparatus 100 a housing 102 handheld by the store clerk or manager, and an in-counter barcode scanner 104 mounted on the housing 102 capable of scanning and decoding barcodes information from the barcode chip.

The in-counter barcode scanner 104 outputs alphanumeric characters encoded in the barcode chip. Examples of in-counter barcode scanner 104 includes but not limited to Honeywell horizon MS7625 code reader MK7625-71B41, and the Datalogic Magellan 2300HS Barcode Scanner M230D-00111-05040R etc.

The barcode reader apparatus 100 includes a memory unit 106 mounted in the housing 102 for storing vendor's bank name, vendor's bank account number, routing number of the vendor's bank account, vendor's name, a special code and price of each product. Further, in another preferred embodiment of the present invention, the memory unit 106 may store multiple prices for each product i.e. selling price, vendor price and store commission price.

The barcode reader apparatus 100 includes a processor 108 coupled to memory unit 106 and the in-counter barcode scanner 104. The processor 108 is programmed to process a series of steps. The steps initiates with a step 110 to receive decoded alphanumeric characters from the in-counter barcode scanner. In a preferred embodiment of the present invention, the alphanumeric characters are a special code reflecting vendor's information associated with the product.

The step 110 is followed by a step 112 to store the decoded alphanumeric characters in the memory unit 106. In a preferred embodiment, the special code is stored in the memory unit. The step 112 is then followed by a step 114 of analyzing the vendor price and selling price, routing number, and account number and a special code, and vendor's name, and financial institute programmed from the barcode chip.

The step 114 is then followed by a step 116 of communicating with the store's bank/customer's bank for transferring the vendor price associated with the product to the vendor's bank account. This enables the vendor's to receive money directly associated with the product being sold at the store.

The present invention offers various advantages such as eliminating the need of applying for bank loans, or paying factoring company a percentage to buy their account receivable. The vendor's receive money directly and no more waiting period.

Those of skill in the art will appreciate that the herein described apparatus may be subject to various modifications and alternative constructions. There is no intention to limit the scope of the disclosure to the specific exemplary embodiments, applications, and/or constructions described herein. Rather, the herein described devices, systems are intended to cover all modifications, alternative constructions, and equivalents falling within the scope and spirit of the claimed invention and its equivalents.

1. A barcode reader apparatus placed at a store for communicating the store bank with the vendor's bank over a communication network, the barcode reader apparatus scans a barcode chip attached to a product, the barcode reader apparatus comprising:
a housing handheld by the store manager and or clerk;
an in-counter barcode scanner mounted on the housing capable of scanning and decoding barcodes information from the barcode chip, further the in-counter barcode scanner outputs alphanumeric characters encoded in the barcode chip;
a memory unit mounted in the housing for storing vendor's bank name, vendor's bank account number, routing number of the vendor's bank account, vendor's name, a special code and price of each product;
a processor coupled to the memory unit and the in-counter barcode scanner programmed to:
receive decoded alphanumeric characters from the in-counter barcode scanner;
store the decoded alphanumeric characters in the memory unit;
analyze the vendor price and selling price, routing number, and account number and a special code, and vendor's name, and financial institute programmed from the barcode chip; and
communicating with the store's bank and or customer's bank account for transferring the vendor price associated with the product to the vendor's bank account.

2. The barcode reader apparatus of claim 1 wherein the processor is further programmed to send a transaction slip of the purchases to the vendor over the communication network.
